(19) United States
(12) Patent Application Publication
(10) Pub. No.: US 2001/0018292 A1
(43) Pub. Date: Aug. 30, 2001

(54) Mounting assembly for connectors

(76) Inventors: Hiroshi Shimoyama, Isehara-shi (JP); Katsunori Kasahara, Tokyo (JP)

Correspondence Address: Stacey E. Caldwell, Molex Incorporated, 2222 Wellington Court, Lisle, IL, 60532, US

(21) Appl. No.: 09/783,524

(22) Filed: Feb. 14, 2001

(30) Foreign Application Priority Data
Feb. 18, 2000 (JP) 2000/41063

(51) Int. Cl. H02B 1/01

(52) U.S. Cl. 439/573

(57) ABSTRACT

A mounting assembly is provided for mounting a connector onto a substrate. The assembly includes a metal connector shell having an integral mounting bracket with a hole for receiving a fastener extending therethrough from the substrate at one side of the bracket. A fastening nut is engageable with the fastener at an opposite side of the bracket. The fastening nut is releasably retained on the bracket for holding the nut prior to engagement with the fastener.

### FIELD OF THE INVENTION

This invention generally relates to mounting assemblies for electrical connectors and, particularly, to an assembly for mounting an IC card connector onto a substrate.

### BACKGROUND OF THE INVENTION

Electrical connectors often are mounted on substrates, such as panels, printed circuit boards and the like. Examples of mounting structures are shown in Japanese Utility Model Publication Nos. Sho 39-34212 and 3000138 and Japanese Patent Application Laid-Open No. Hei 11-204195.

In addition, many electrical connectors include metal shells or shields, and the shells, in turn, are mounted to the substrate. For instance, FIGS. 9-11 herein show a metal shell, generally designated 14, of an IC (integrated circuit) card connector. The shell is stamped and formed of sheet metal material and includes a pair of mounting brackets 16 projecting outwardly from opposite lateral sides thereof. Each bracket 16 basically is a flat metal plate having a hollow, internally threaded boss 18 formed out of the plate and projecting upwardly therefrom as best seen in FIG. 12. Appropriate fasteners, such as externally threaded bolts, are inserted through the substrate in the direction of arrows “A” (FIG. 12) and are threaded into bosses 18 to mount the shell onto the substrate.

Aside from the fact that prior art shell 14 with brackets 16 has an excessive width “W”, this system has a number of problems or disadvantages. First, brackets 16 are stamped and formed as discrete parts and then fixed, as by welding, to the shell. This increases the cost of the shell as well as the assembly time therefor. In addition, the metal internally threaded bosses 18 may be deformed or damaged or their threads may be stripped, and the entire shell 14 must be discarded. Still further, a variety of fasteners may be used to mount the shell to the substrate, such as different sized fasteners or fasteners with different thread pitches. With brackets 16 and internally threaded bosses 18 being integral with shell 14, different shells for different fasteners must be maintained in inventory, and this further increases the costs in using such prior art mounting systems.

Approaches have been made to providing separate internally threaded nuts on the mounting brackets of the shell. However, provisions must be made to prevent the nuts from falling off the brackets. Heretofore, such nuts either have been tightly press-fit on the brackets or bonded or welded thereto. Such systems significantly increase the assembly costs and also prevent the nuts from being readily released or replaced or interchanged.

The present invention is directed to solving these problems in mounting metal connectors shells to appropriate substrates.

### SUMMARY OF THE INVENTION

An object, therefore, of the invention is to provide a new and improved mounting assembly for mounting a connector onto a substrate.

In the exemplary embodiment of the invention, the mounting assembly includes a metal connector shell having an integral mounting bracket with a hole for receiving a fastener extending therethrough from the substrate at one side of the bracket. A fastening nut is provided for engaging the fastener at an opposite side of the bracket. Complementary interengaging releasable retaining means are provided between the mounting bracket and the fastening nut for holding the nut on the bracket prior to engagement with the fastener.

As disclosed herein, the metal connector shell is a generally flat shell of an IC card connector. At least one of the mounting brackets projects outwardly from each of two opposite sides of the shell. The shell is stamped and formed of sheet metal material, with the mounting brackets being stamped and formed integral with the shell. The hole in each mounting bracket is formed in a plate portion thereof.

According to one aspect of the invention, the fastening nut includes a body having a through hole for receiving the fastener. As disclosed, the through hole is internally threaded for threadedly engaging an externally threaded fastener bolt.

According to another aspect of the invention, the complementary interengaging releasable retaining means include first and second retention portions at opposite sides of the retaining nut engageable with first and second retention portions, respectively, at opposite sides of the mounting bracket. The first retention portion at one side of the retaining nut comprises a projection, and the first retention portion at one side of the mounting bracket comprises an opening for receiving the projection. The second retention portions of the retaining nut and the mounting bracket comprise complementary interengaging snap-latch means at the opposite sides of the nut and the bracket for latching the retaining nut to the mounting bracket after the projection at the one side of the nut is inserted into the opening at the one side of the bracket. The snap-latch means is formed by at least one latch hook on the bracket engageable with a latch shoulder on the nut. The opening in the bracket for receiving the projection on the nut is in a flexible arm portion of the bracket to allow the arm portion to flex and the nut to yield therewith as the latch shoulder of the nut latchingly snaps behind the latch hook of the bracket.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an IC card connector shell and related components, with a mounting assembly according to the invention;

FIG. 2 is a perspective view of the fastening nut of one of the mounting assembly;

FIG. 3 is a perspective view of the integral mounting bracket of the mounting assembly;

FIG. 4 is a perspective view of the nut of FIG. 2 assembled in the bracket of FIG. 3;

FIG. 5 is a top plan view of the metal shell;

FIG. 6 is a side elevational view of the shell;

FIG. 7 is an end elevational view of the shell;

FIGS. 8A-8G are sequential side elevational views showing the nut of FIG. 2 being assembled into the bracket of FIG. 3; and

FIGS. 9-11 are top plan, side elevational and end elevational views, respectively, of the prior art shell described in the “Background”, above.

### DETAILED DESCRIPTION OF THE PREFERRED EMBODIMENT

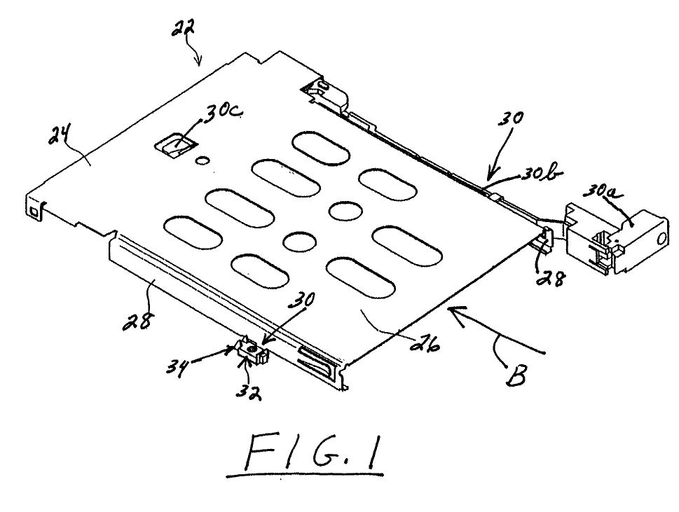

Referring to the drawings in greater detail, and first to FIG. 1, the invention is embodied in a mounting assembly, generally designated 20, for mounting an IC card connector, generally designated 22, onto a substrate (not shown). Generally, the IC card connector includes a stamped and formed sheet metal shell, generally designated 24, which includes a top wall or plate 26 spaced above the substrate by a pair of longitudinal side walls 28. An IC card is inserted beneath top plate 26 between side walls 28 in the direction of arrow “B”. An eject mechanism, generally designated 30 and including a push button 30a, a slide rod 30b and an internal eject lever 30c, is used to eject the IC card back out of the connector. One of the mounting assemblies 20 is located outside each side wall 28 of shell 24, although only one of the mounting assemblies is visible in FIG. 1. Although the mounting system or assemblies of the invention are shown herein for use with an IC card connector and shell therefor, it should be understood that the invention is equally applicable for use with a variety of other types of connectors and connector shells.

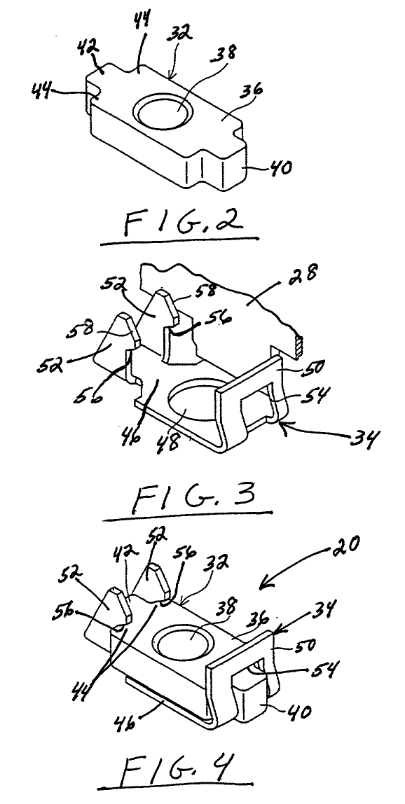

Referring to FIGS. 2 and 3 in conjunction with FIG. 1, each mounting assembly 20 includes a fastening nut, generally designated 32 (FIG. 2), which is releasably mounted within a mounting bracket, generally designated 34 (FIG. 3). Fastening nut 32 includes a body 36 having a through hole 38 for receiving a fastener projecting upwardly from the substrate to which connector 22 and shell 24 are mounted. The body may be made of dielectric material such as plastic or the like, or the body may be fabricated of metal material. In either event, through hole 38 may be internally threaded (not shown) for receiving an externally threaded fastener bolt. A first projection 40 projects from one end of body 36 of nut 32, and a second projection 42 projects from the opposite end of the body. A pair of latch shoulders 44 are defined on top of the body at opposite sides of second projection 42, for purposes described hereinafter.

FIG. 3 shows bracket 34 to be integral with one of the side walls 28 of metal shell 24. Therefore, the bracket is stamped and formed from the same sheet metal material as the shell. The bracket includes a flat bottom plate 46 having a through hole 48. A flexible arm 50 extends upwardly from one end of bottom plate 46, and a pair of rigid latch arms 52 extend upwardly from the opposite end of the bottom plate. With the bracket stamped and formed of sheet metal material, arm 50 is flexible because it lies in a plane transverse of the movement of fastening nut 32 described hereinafter. Arms 52 are rigid because the planes of the sheet metal material from which the latch arms are fabricated are generally parallel to the movement of the fastening nut. Finally, flexible arm 50 has an opening 54 therethrough, and each latch arm 52 has an inwardly directed latch hook 56 as well as a top chamfered edge 58.

FIG. 4 shows the retaining nut 32 of FIG. 2 mounted within the mounting bracket 34 of FIG. 3. It can be seen that first projection 40 at one end of body 36 of the nut is positioned within opening 54 in flexible arm 50 of the bracket. Latch shoulders 44 of the nut are latched behind latch hooks 56 of the bracket. When so assembled, internally threaded hole 38 in the nut is aligned with through hole 48 (not visible) in the bracket.

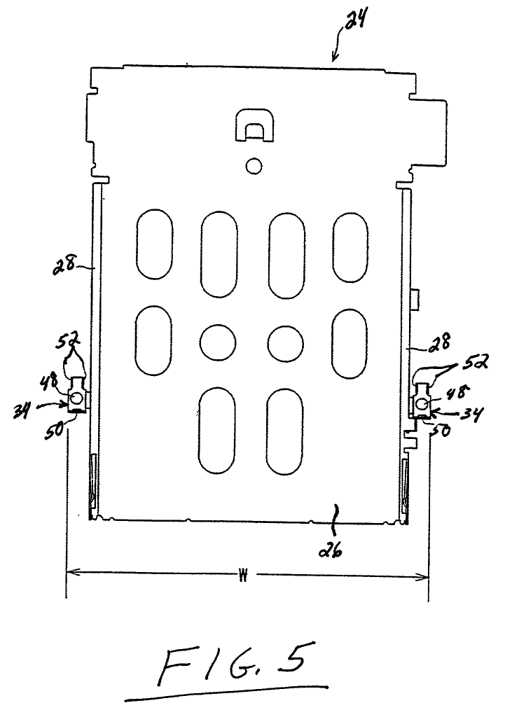

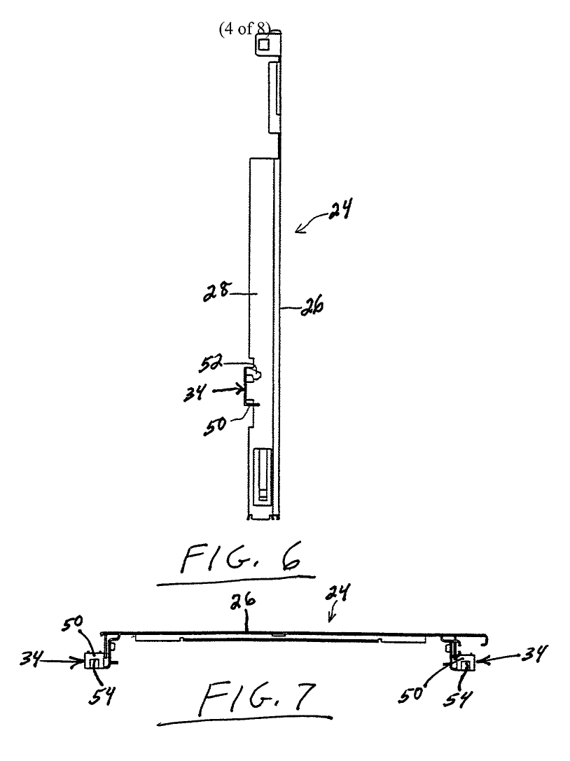

FIGS. 5-7 show stamped and formed sheet metal shell 24 isolated from connector 22 (FIG. 1). It can be seen that one of the mounting brackets 34 projects outwardly from each side wall 28 of the shell to define an overall width dimension “W” near the front of the shell. As stated above, the mounting brackets are stamped and formed of conductive sheet metal material integral with the stamped and formed sheet metal shell.

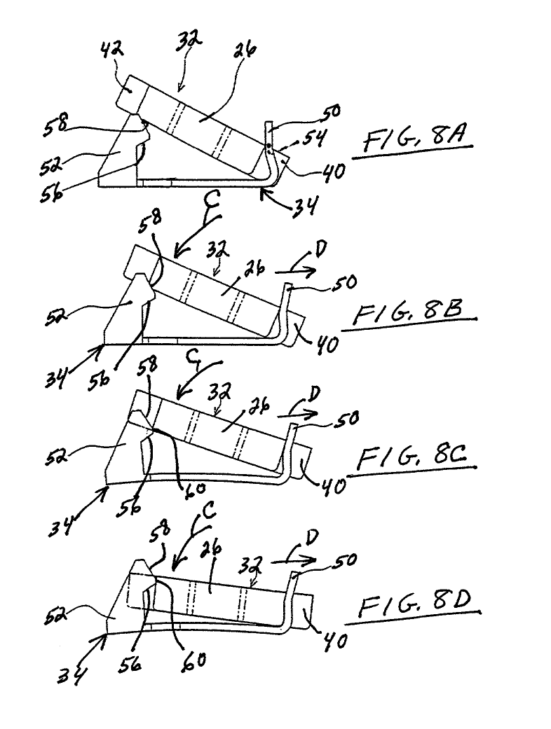

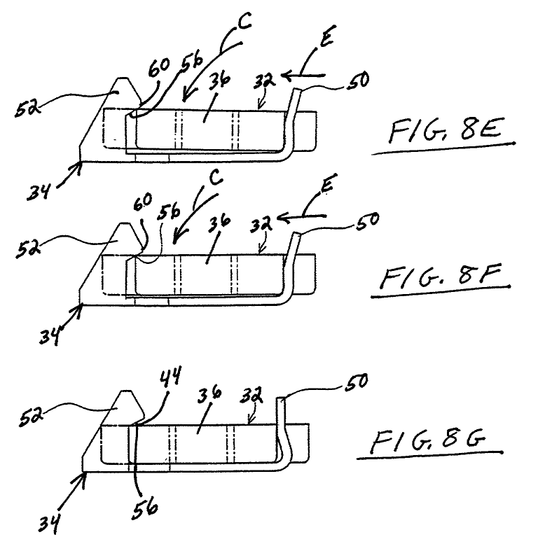

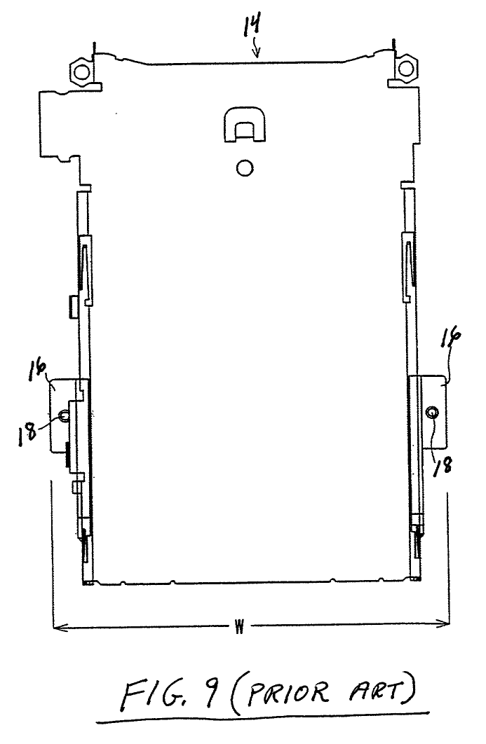

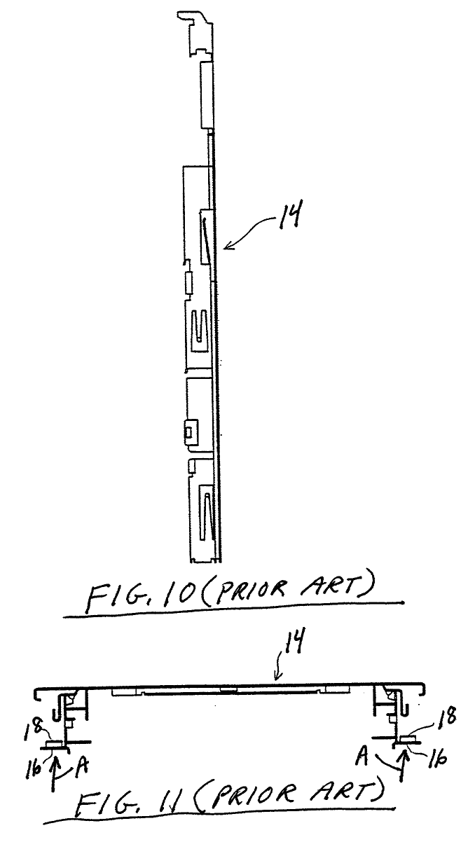

FIGS. 8A-8G show the sequence of assembling one of the retaining nuts 32 into one of the mounting brackets 34. The assembly process begins by inserting first projection 40 at one end of the nut into opening 54 in flexible arm 50 of the bracket as seen in FIG. 8A. At this point, body 36 of the nut simply rests on top of latch arms 52.

Nut 32 then is pushed downwardly in the direction of arrow “C” into engagement with top chamfered edges 58 of latch arms 52 as seen in FIG. 8B. During this movement, the interengagement of first projection 40 of the nut within opening 54 of flexible arm 50 of the bracket, acts as a fulcrum means about which the nut rotates downwardly in the direction of arrow “C”.

The nut continues to be pushed downwardly as shown in FIGS. 8C and 8D along top chamfered edges 58 of latch arms 52 and along inside noses 60 of the latch arms. During the pivotal movement of nut 32 into bracket 34 as shown in FIGS. 8B-8D, flexible arm 50 is flexed outwardly in the direction of arrows “D” so that the body of the nut can pass downwardly and inwardly along top chamfered edges 58 and noses 60 of latch arms 52.

FIGS. 8E-8G show how final movement of nut 32 into bracket 34 in the direction of arrows “C” causes body 36 of the nut to move downwardly and transversely to a final assembled position shown in FIG. 8G wherein latch shoulders 44 of the nut are latched beneath latch hooks 56 of the bracket. During this final movement, after the body of the nut has cleared noses 60 of latch arms 52 of the bracket, flexible arm 50 is effective to bias the nut in the direction of arrows “E” until the nut is latched beneath latch hooks 56. In other words, energy is stored in flexible arm 50 as it moves outwardly in the direction of arrows “D” (FIGS. 8B-8D), and this stored energy is effective to seat the nut under latch hooks 56 in its final assembled position.

Finally, referring back to FIG. 2, it can be seen that retaining nut 32 is symmetrical at opposite ends thereof. Therefore, the nut can be assembled to bracket 34 with either first projection 40 or second projection 42 of the nut first being inserted into opening 54 in flexible arm 50 of the bracket. In order to remove the nut for replacement or interchangeable purposes, the process described above in relation to FIGS. 8A-8E simply is reversed. The nut would be pushed against flexible arm 50 until the body of the nut clears inside noses 60 of latch arms 52, and the nut simply would be pulled out of the bracket to replace the nut or interchange the nut with another nut having a differently sized hole 38 for a different sizes fastener.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. A mounting assembly for mounting a connector onto a substrate, comprising:
a metal connector shell including an integral mounting bracket having a hole for receiving a fastener extending therethrough from the substrate at one side of the bracket;
a fastening nut for engaging the fastener at an opposite side of the bracket; and
complementary interengaging releasable retaining means between the mounting bracket and the fastening nut for holding the nut on the bracket prior to engagement with said fastener.

2. The mounting assembly of claim 1 wherein said connector shell is stamped and formed of sheet metal material with the mounting bracket being stamped and formed integral with the shell.

3. The mounting assembly of claim 2 wherein said hole in the mounting bracket is formed in a plate portion thereof.

4. The mounting assembly of claim 1 wherein said fastening nut includes a body having a through hole for receiving said fastener.

5. The mounting assembly of claim 4 wherein said through hole is internally threaded for threadedly engaging an externally threaded fastener bolt.

6. The mounting assembly of claim 1 wherein said complementary interengaging releasable retaining means includes first and second retention portions at opposite sides of the retaining nut engageable with first and second retention portions, respectively, at opposite sides of the mounting bracket.

7. The mounting assembly of claim 6 wherein said first retention portion at one side of the retaining nut comprises a projection, and said first retention portion at one side of the mounting bracket comprises an opening for receiving the projection.

8. The mounting assembly of claim 7 wherein said second retention portions of the retaining nut and the mounting bracket comprise complementary interengaging snap-latch means at the opposite side of the nut and bracket for latching the retaining nut to the mounting bracket after said projection at the one side of the nut is inserted into the opening at the one side of the bracket.

9. The mounting assembly of claim 8 wherein said complementary interengaging snap-latch means comprise at least one latch hook on the mounting bracket engageable with a latch shoulder on the retaining nut.

10. The mounting assembly of claim 9 wherein said opening in the mounting bracket for receiving the projection on the retaining nut is in a flexible arm portion of the bracket to allow the arm portion to flex and the retaining nut to yield therewith as the latch shoulder of the nut latchingly snaps behind the latch hook of the bracket.

11. The mounting assembly of claim 1 wherein said metal connector shell comprises a generally flat shell of an IC card connector.

12. The mounting assembly of claim 11, including at least one of said mounting brackets projecting outwardly from each of two opposite sides of the shell.

13. A mounting assembly for mounting an IC card connector onto a substrate, comprising:
a generally flat metal connector shell stamped and formed of sheet metal material and including an integral stamped and formed mounting bracket having a hole in a plate portion thereof for receiving a fastener extending therethrough from the substrate at one side of the bracket;
a fastening nut including a body having a through hole for receiving the fastener at an opposite side of the bracket; and
complementary interengaging releasable retaining means between the mounting bracket and the fastening nut for holding the nut on the bracket prior to engagement with said fastener.

14. The mounting assembly of claim 13 wherein said through hole in the fastening nut is internally threaded for threadedly engaging an externally threaded fastener bolt.

15. The mounting assembly of claim 13 wherein said complementary interengaging releasable retaining means includes first and second retention portions at opposite sides of the retaining nut engageable with first and second retention portions, respectively, at opposite sides of the mounting bracket.

16. The mounting assembly of claim 15 wherein said first retention portion at one side of the retaining nut comprises a projection, and said first retention portion at one side of the mounting bracket comprises an opening for receiving the projection.

17. The mounting assembly of claim 16 wherein said second retention portions of the retaining nut and the mounting bracket comprise complementary interengaging snap-latch means at the opposite side of the nut and bracket for latching the retaining nut to the mounting bracket after said projection at the one side of the nut is inserted into the opening at the one side of the bracket.

18. The mounting assembly of claim 17 wherein said complementary interengaging snap-latch means comprise at least one latch hook on the mounting bracket engageable with a latch shoulder on the retaining nut.

19. The mounting assembly of claim 18 wherein said opening in the mounting bracket for receiving the projection on the retaining nut is in a flexible arm portion of the bracket to allow the arm portion to flex and the retaining nut to yield therewith as the latch shoulder of the nut latchingly snaps behind the latch hook of the bracket.

20. The mounting assembly of claim 13, including at least one of said mounting brackets projecting outwardly from each of two opposite sides of the shell.
